(19) United States
(12) Patent Application Publication
(10) Pub. No.: US 2023/0244636 A1
(43) Pub. Date: Aug. 3, 2023

(54) UTILIZATION-BASED TRACKING DATA RETENTION CONTROL

(71) Applicant: Microsoft Technology Licensing, LLC, Redmond, WA (US)

(72) Inventor: Ryan Thomas RUSSELL, The Colony, TX (US)

(21) Appl. No.: 17/589,113

(22) Filed: Jan. 31, 2022

(51) Int. Cl. G06F 16/11; G06F 16/28

(52) U.S. Cl. CPC G06F 16/125; G06F 16/285; G06F 3/0608

(57) ABSTRACT

Computational resources are used for storing, processing, and transmitting logs, metrics, and other tracking data. Usage of such resources may be reduced by reducing the retention of identified tracking data subsets, based on the subsets' respective utilization levels, after monitoring activities that review a subset or at least request a subset for review. Efficient usage of tracking data subsets may be increased, as measured by signal-to-noise fractions, wherein signal strength corresponds to subset utilization in monitored review activities. Tracking data resource usage efficiency may be gained whether the amount of resources used is increased, maintained, or reduced. Resource usage control functionality may be integrated with security orchestration and automation, security information and event management, workload management, laws, entity policies, operational requirements, usage goals, or application dependencies, even in legacy systems.

### BACKGROUND

Noon Computing systems include, provide, or utilize a wide variety of different computational resources. Hardware processors, software instructions, and virtual machines are some examples of compute resources. Volatile random access memory, non-volatile hard drives, and storage data structures are some examples of storage resources; storage data structures include files, file directories, storage volumes, blobs, and various other data structures. Network bandwidth and the associated networking hardware and software are examples of network resources. A given computing system artifact may involve multiple kinds of computational resources. A virtual machine or a stream, for example, each involve compute resources, storage resources, and network resources.

Many computational resources involve data, e.g., compute resources process data, storage resources store data, and network resources transmit data. Computational resources can often be assessed in various ways with respect to their involvement with data. A virtual machine, for example, may be assessed as to how accurately and quickly it processes data, how often it is idle due to a lack of data, how secure the data is within the virtual machine or while traveling between virtual machines, how much data is stored within the virtual machine, how accurately and quickly data travels between virtual machines, how well the virtual machine and its operations protect the privacy of the data, who has what access rights or responsibilities regarding the virtual machine and the data, and how much the particular virtual machine costs compared to alternative artifacts.

Accordingly, advancements in computational resources and in their usage may be beneficial in various ways.

### SUMMARY

Some embodiments described herein help reduce the usage of computational resources that involve tracking data. Tracking data includes security log data, performance log data, and data that tracks system health over time, for example. Although tracking data is often useful, or even necessary, in order for a computing system to have a particular desired characteristic, not all tracking data is equally useful. One way an embodiment may computationally assess tracking data usefulness is to monitor activities that could rely on the tracking data. These activities include tracking data review activities, in which particular tracking data is requested for review, or is actually reviewed, or both.

The less a particular subset of tracking data is accessed during review activities, the less likely that tracking data is to be missed if it is not retained. By decreasing the retention of tracking data that will likely not be missed, an embodiment may reduce the usage of computational resources to store that data, transmit that data, and process that data.

Some embodiments identify a subset of tracking data, monitor review activities which access that tracking data subset, and assign a utilization level to the subset based on a result of monitoring the review activities. The subset may be defined by its characteristics, as opposed to being defined as a specific set of data values. Based on the utilization level, the embodiments formulate a retention recommendation about the tracking data subset, and they provide the retention recommendation to a mechanism that controls an aspect of the retention of that tracking data subset. In this way, the embodiments may facilitate safe reduction of computational resource usage by reducing the retention of tracking data which is, for instance, duplicative or cumulative, or whose non-retention is not adversely impactful. Other aspects of utilization-based tracking data retention control functionalities are also described herein.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems and also illustrating configured storage media;

FIG. 2 is a block diagram illustrating aspects of a computing system which has one or more of the resource usage reduction enhancements taught herein;

FIG. 3 is a block diagram illustrating an enhanced system configured with resource usage reduction functionality;

FIG. 4 is a block diagram illustrating aspects of some tracking data review activity monitoring mechanisms;

FIG. 5 is a block diagram illustrating aspects of some tracking data;

FIG. 6 is a block diagram illustrating aspects of some tracking data retention recommendations;

FIG. 7 is a block diagram illustrating aspects of some tracking data utilization levels;

FIG. 8 is a flowchart illustrating steps in some resource usage reduction methods; and

FIG. 9 is a flowchart further illustrating steps in some resource usage reduction methods, incorporating FIG. 8.

### DETAILED DESCRIPTION

### Overview

Innovations may expand beyond their origins, but understanding an innovation's origins can help one more fully appreciate the innovation. In the present case, some teachings described herein were motivated by technical challenges arising from a goal of safely reducing computational resource usage in Azure® clouds and other computing environments (mark of Microsoft Corporation).

In particular, an innovator observed that as a cloud service provider Microsoft consumed extremely large amounts (over a billion dollars' worth) of storage yearly for logs intended to support efforts to maximize the availability and performance of customer applications and services. Some views hold that less than ten percent of such logs are useful signals, while the rest is noise. However, common attitudes hold that “storage is cheap” and that it is “better to have it and not need it.”

The innovator concluded that logging and metrics are areas of increasing cost for businesses. Applications and systems are emitting ever-increasing volumes of data and increasing numbers of systems are being deployed. This causes the storage, indexing, searching, and other compute (e.g., rollups, machine learning, etc.) costs to increase at a ballooning rate. This increase may be exacerbated by engineering and development teams emitting data without knowing whether the specific emitted parameters will actually be required later.

When trying to decide whether to remove certain parameters from logs or metrics, teams may be hesitant to remove anything because they may not have a good system in place to track what data elements or tracked parameters are used for troubleshooting and investigations. Informal surveys by email or other means may easily fail to identify all users of particular data, for example. A “scream test” could be performed by abruptly making certain data unavailable, but the problem with such a test is reflected in the name—making colleagues or customers annoyed enough to feel like screaming is far from optimal.

Compounding the above considerations is the fact that on the storage side there are often redundancy, resiliency, backup, and speed considerations. As a result, any given piece of data is likely replicated at least three to five times. Data retrieval may also involve copies from fronting or caching via media such as flash storage. Between the disks, the hardware housing them, power costs, and other costs incidental to data storage, the costs of storage can quickly grow. Indeed, storage costs may grow at a near-exponential rate, especially in circumstances that do not benefit from economies of scale.

The innovator recognized that there are many ways to address data storage challenges, with perhaps the most common being to buy more storage. Some other efforts include compression, tiering that moves less frequently accessed data to cheaper storage media, and transitioning to cloud storage to benefit from economies of scale. None of these approaches is ruled out by the teachings provided herein.

The innovator focused on the challenges of reducing resource usage by reducing the retention of tracking data. Teachings provided herein can supplement approaches such as compression and tiering, by providing implementable ways to determine computationally which part of tracking data may safely be treated as noise. After “noise” is identified in log data or metrics data, adjustments can be made to reduce the retention of that noise data, which in turn reduces the costs of storing, processing, and transmitting log data or metrics data.

A threshold technical challenge faced by the innovator was therefore how to define “noise” in the context of log data, metrics data, and other tracking data. Once identified, the “noise” can be safely phased out of retention, or even have its retention terminated abruptly if a less cautious approach is taken. An over-inclusive definition of “noise” would result in the loss of tracking data that is needed later. An under-inclusive definition would avoid such loss, but would also decrease the benefits that flow from retaining less tracking data.

Many of the teachings herein may be applied with a variety of definitions of “noise”. For example, the particular definition of “noise” used does not eliminate the benefits of the present disclosure's teaching that tracking data usefulness may be assessed based on review activities, or its teaching that a distinction may be made between requesting tracking data for possible review and actually reviewing tracking data, or the many teachings documented herein as limitations of dependent claims.

Some embodiments define noisy tracking data as data 118 which is duplicative, cumulative, or whose removal or decreased retention is not adversely impactful. Some embodiments use only two of these criteria, e.g., duplicative data or cumulative data is noisy. Some embodiments use only one of these criteria, e.g., non-impactful data is treated as noisy data.

Particular data is “duplicative” in a given system when there is more than one available copy of that data in the system.

Particular data is “cumulative” when it can be recalculated from other data that is available in the system.

Particular data is “non-impactful” when making the data unavailable for review activities does not adversely change any relevant measured system behavior by more than a specified percent or absolute amount. This may also be described as the data not being adversely impactful at the specified level. Unless otherwise stated, the relevant characteristics are storage usage, processing speed, and bandwidth usage, but other characteristics may be used in addition or instead in a given system. For example, in one example system an adverse change of more than 5% in any quantified measure of any of the following is defined as adversely impactful: storage usage, processing speed, transmission bandwidth usage, security (confidentiality, integrity, or availability), privacy, accuracy, user satisfaction, regulatory compliance, or business enterprise policy compliance. Other embodiments use a 10% cutoff, or a 2% cutoff, for example.

Unless otherwise indicated, “non-impactful” means not adversely impactful. However, in general an impact may be adverse or beneficial. When beneficial impact is meant herein, “impactful” will be qualified by a term such as “beneficial”, “positive”, or “advantageous”. For example, in some cases some embodiments reduce retention of tracking data in a way that is beneficially impactful at a ten percent level for at least one of: tracking data processing time (faster processing) or tracking data storage size (smaller storage).

In view of the foregoing, the innovator devised a system which keeps track of which tracking data attributes are filtered on, queried on, or otherwise reviewed. Tracking data review may be monitored per user, per group, per application, and so forth, such that over time the system may begin making tracking data retention recommendations based on the review activities.

For example, a tracking data retention recommendation might include a statement along the lines of “It looks like parameters H-Z are used in 0% of user queries, so consider removing these from log/metrics output”, or a statement such as “It looks like parameters B, C, and E are used in 7% of user queries, so consider reducing their retention time”, or “It looks like parameters A, D, F, and G are used in 95% of user queries, so these should be preserved”. These are merely examples. One of skill will understand that many other kinds of retention recommendation statements are contemplated.

One of skill will also understand that implementing a retention recommendation does not necessarily include displaying such a statement. Implementing a retention recommendation may also involve more than displaying a statement. Regardless of any statement display, in some cases logging or auditing configurations may be changed, workload tickets may be generated, or alerts may be raised.

Additional technical challenges arose. One challenge was how to monitor review activities, which teachings herein address by describing a variety of review activity monitoring mechanisms.

Another challenge was whether to integrate automatically formulated retention recommendations with a security orchestration and automated response (SOAR) mechanism, which teachings herein address by describing use of a SOAR playbook as a basis for retention recommendations.

Another challenge was what to use as one or more bases for retention recommendations, which teachings herein address by describing various bases such as a tracking data utilization level, SOAR playbook, legal requirement, company requirement, prediction, operational requirement, application dependency, and retention goal. A constituent challenge was how to determine a suitable tracking data utilization level, which is addressed by delimiting or filtering tracking data, or by calculating a relative proportion (e.g., a percentage) or a frequency of review activity, for example.

More generally, the present disclosure provides technical mechanisms to address these and other challenges, in the form of computational resource usage control functionalities tailored for managing the retention of tracking data in order to safely reduce resource usage or satisfy specified requirements or specified aspirational goals. These functionalities may be used in various combinations with one another, or alone, in a given embodiment.

### Operating Environments

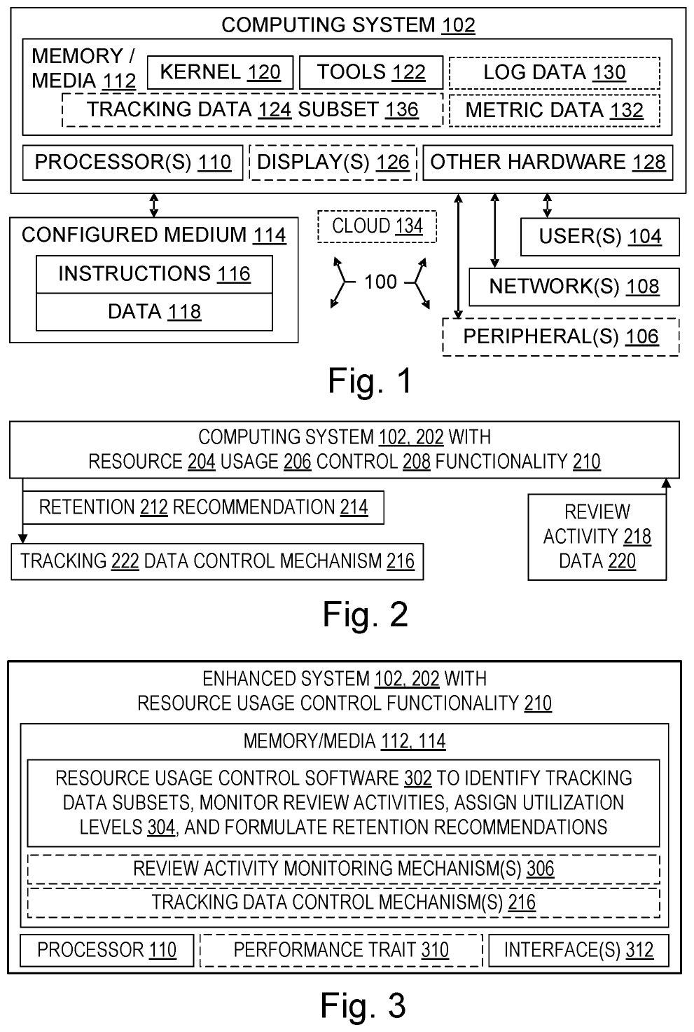

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. Virtual reality or augmented reality or both functionalities may be provided by a system 102. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of human user 104. Automated agents, scripts, playback software, devices, and the like running or otherwise serving on behalf of one or more humans may also have accounts, e.g., service accounts. Sometimes an account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a cloud 134 and/or other network 108 via network interface equipment, for example.

Each computer system 102 includes at least one processor 110. The computer system 102, like other suitable systems, also includes one or more computer-readable storage media 112, also referred to as computer-readable storage devices 112. Log data 130, metrics data 132 and other kinds of tracking data 124 may reside in media 112. Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs, GPUs, and/or quantum processors), memory/storage media 112, peripherals 106, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, computational resource usage control functionality could be installed on an air gapped network and then be updated periodically or on occasion using removable media 114. A given embodiment may also communicate technical data and/or technical instructions through direct memory access, removable or non-removable volatile or nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

### More About Systems

FIG. 2 illustrates a computing system 102 configured by one or more of the computational resource usage control enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an enhanced system 202 which is configured with software 302 to provide computational resource usage control functionality 210.

FIG. 3 items are discussed at various points herein, and additional details regarding them are provided in the discussion of a List of Reference Numerals later in this disclosure document.

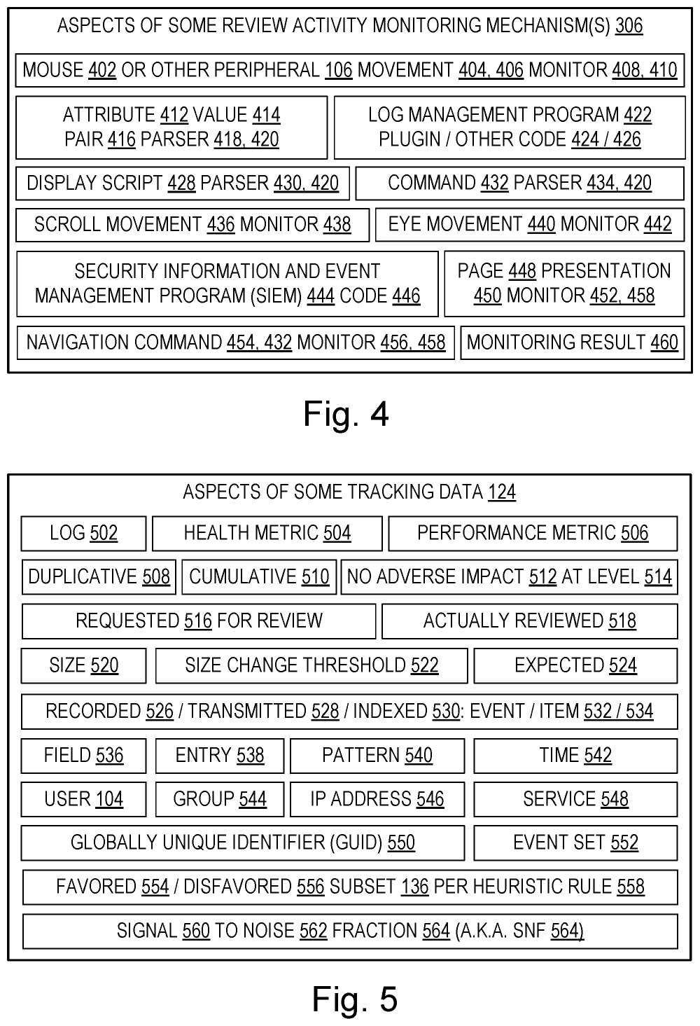

FIG. 4 shows some aspects of review activity monitoring mechanisms 306. This is not a comprehensive summary of all review activities 218 or of every view activity monitoring mechanism 306. FIG. 4 items are discussed at various points herein, and additional details regarding them are provided in the discussion of a List of Reference Numerals later in this disclosure document.

FIG. 5 shows some aspects of tracking data 124. This is not a comprehensive summary of all tracked or trackable events or hardware or of every kind of tracking data 124 or every possible criterion for delimiting a subset 136 of tracking data 124. FIG. 5 items are discussed at various points herein, and additional details regarding them are provided in the discussion of a List of Reference Numerals later in this disclosure document.

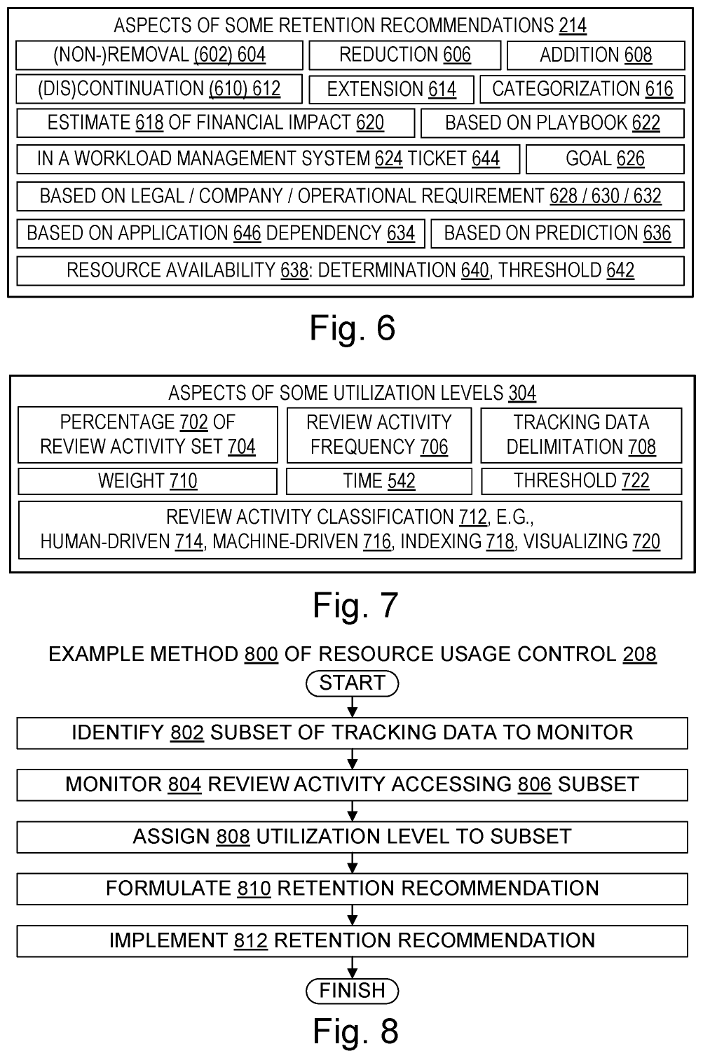

FIG. 6 shows some aspects of tracking data retention recommendations 214, which are also referred to herein simply as “retention recommendations” or as “recommendations”. This is not a comprehensive summary of all tracking data retention recommendations. FIG. 6 items are discussed at various points herein, and additional details regarding them are provided in the discussion of a List of Reference Numerals later in this disclosure document.

FIG. 7 shows some aspects of tracking data utilization levels 304, which are also referred to herein simply as “utilization levels”. This is not a comprehensive summary of all tracking data utilization levels or all ways to measure utilization of tracking data. FIG. 7 items are discussed at various points herein, and additional details regarding them are provided in the discussion of a List of Reference Numerals later in this disclosure document.

In some embodiments, the enhanced system 202 may be networked through an interface 312. An interface 312 may include hardware such as network interface cards, software such as network stacks, APIs, or sockets, combination items such as network connections, or a combination thereof.

In some embodiments, the enhanced system 202 is configured for controlling computational resource usage. The enhanced system 202 includes a digital memory 112 and a processor 110 in operable communication with the memory. The digital memory 112 may be volatile or nonvolatile or a mix. The processor 110 is configured to perform safe computational resource usage control steps. The steps include (a) identifying 802 subsets 136 of tracking data 124, the tracking data including event log data 130 or computing system metric data 132 or both, (b) monitoring 804 review activities 218 which access 806 respective tracking data subsets, (c) assigning 808 a utilization level 304 to a tracking data subset based 930 on at least a result 460 of the review activities monitoring 804, (d) formulating 810 a retention recommendation 214 about the tracking data subset, the retention recommendation based 930 at least on the utilization level; and (e) providing 902 the retention recommendation to a tracking data control mechanism 216.

In many but not necessarily all cases, implementing a retention recommendation will reduce resource usage. For example, the recommendation 214 may call fora reduction in a retention 212 period of a particular tracking data subset, which then leads to reduced resource usage after a system archival management software configuration 216 is updated to match the retention recommendation.

Although reducing the retention period of any randomly selected tracking data subset would likely also reduce resource usage, the reduction attained by following the recommendation 214 is “safe” in the sense that tracking data which is being sufficiently utilized will not be recommended for decreased retention or outright removal. What qualifies as “sufficiently utilized” is a function of a utilization level threshold 722, which may be a default value, be set by an admin, or be based on statistical or machine learning model results, for example. The utilization level is based on the review activity monitoring results.

In some cases, implementing a retention recommendation may keep resource usage at the same level, or even increase resource usage, but will nonetheless improve a signal-to-noise fraction (SNF) of the tracking data. As used herein, a signal-to-noise fraction is a measure of utilized tracking data to non-utilized tracking data, or more subtly a measure of more-utilized tracking data to less-utilized tracking data.

In other words, there are at least two ways in which implementing a retention recommendation may be beneficial. As a first benefit, the usage of computational resources involved in tracking data storage or tracking data processing or tracking data transmission may be reduced. For instance, in a given circumstance the daily tracking data in a particular category might consume 120 GB after an implementation of a retention recommendation, where before the implementation the same category of tracking data consumed 150 GB. Or the time spent performing a predefined security query on logged data from a set of servers might be reduced from 3 minutes to 45 seconds, for instance. As a second benefit, the SNF of tracking data may be improved. For instance, the SNF of health monitoring data might be increased by five percent. In some situations, only one of these benefits results from the implementation of a retention recommendation, while in others both kinds of benefit are realized.

A signal portion of an SNF calculation may be defined, e.g., as:

S=Sum((amount of data at ULi)*(ULi)) over all nonzero utilization levels ULi (1)

A noise portion of the SNF calculation may be defined, e.g., as:

N=Sum(amount of data at utilization level zero) (2)

Then the signal-to-noise fraction may be defined, e.g., as:

SNF=S/(S+N) (3)

As an example A, assume utilization levels are one or zero, assume one GB of tracking data has utilization at level one and ninety-nine GB of tracking data has utilization at level zero. Then SNF=1 GB/(1 GB+99 GB)=0.01=1%.

As an example B, assume utilization levels are 1.0, 0.5, or 0.0, assume 5 GB of tracking data has utilization at level 1.0, 12 GB has utilization level 0.5, and 83 GB of tracking data has utilization at level 0.0. Then SNF=(5 GB+6 GB)/(11 GB+83 GB) =about 0.12 =about 12%.

Other formulas could also be used. For instance, in example B the 12 GB at utilization level 0.5 is contributing both signal and noise, but the noise portion of that contribution is not reflected in formula (2). A different SNF calculation could weight each clump of tracking data according to its signal contribution and also according to its noise contribution. However, the formula given here has an advantage of being easy to calculate while nonetheless being useful as an indication of how much resource usage might be improved by implementing appropriate retention recommendations.

Regardless of the specific SNF calculation employed, a higher signal-to-noise fraction indicates that more of the tracking data has been utilized, or that the tracking data has been more utilized, or both. Either improvement in SNF indicates a better return (from a recommendation 214 implementation) on the costs incurred in storing, processing, and transmitting tracking data.

Some embodiments obtain 804 review activity data 220 from one or more review activity monitoring mechanisms 306 which are configured to ascertain which tracking data 124 is reviewed. Some examples of review activity monitoring mechanisms 306 include a mouse movement monitor 408, a navigation command monitor 456, a display script parser 430, a command parser 434, an attribute-value pair data structure parser 418, a plugin 424 for a log management program 422, a software code 426 operable in a log management program 422, a software code 446 operable in or with a security information and event management program 444, a scroll movement monitor 438, a page presentation monitor 452, and an eye movement monitor 442.

Some embodiments implement 812 the retention recommendation via a tracking data control mechanism 216. In some cases, an external tracking data control mechanism is instructed by an embodiment, while in other cases the embodiment includes one or more tracking data control mechanisms 216 and utilizes them to implement 812 retention recommendations. Some examples of tracking data control mechanisms 216 include a logging configuration file, an auditing configuration file, a log shipping agent, a log forwarder, a log storage system retention configuration, and a log aggregator system retention configuration. Tracking data control mechanisms 216 may be located at one or more levels of an architecture, e.g., in underlying storage, at an aggregator, as an individual machine's top-level configuration, as a log shipper configuration, and so on.

Other system embodiments are also described herein, either directly or derivable as system versions of described processes or configured media, duly informed by the extensive discussion herein of computing hardware.

Although specific resource usage control system 202 architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different review activity monitoring mechanisms 306, tracking data control mechanisms 216, or kinds of tracking data 124, for example, as well as other technical features, aspects, mechanisms, rules, operational sequences, data structures, or other resource usage control functionality teachings noted herein, and may otherwise depart from the particular illustrative examples provided.

### Processes (a.k.a. Methods)

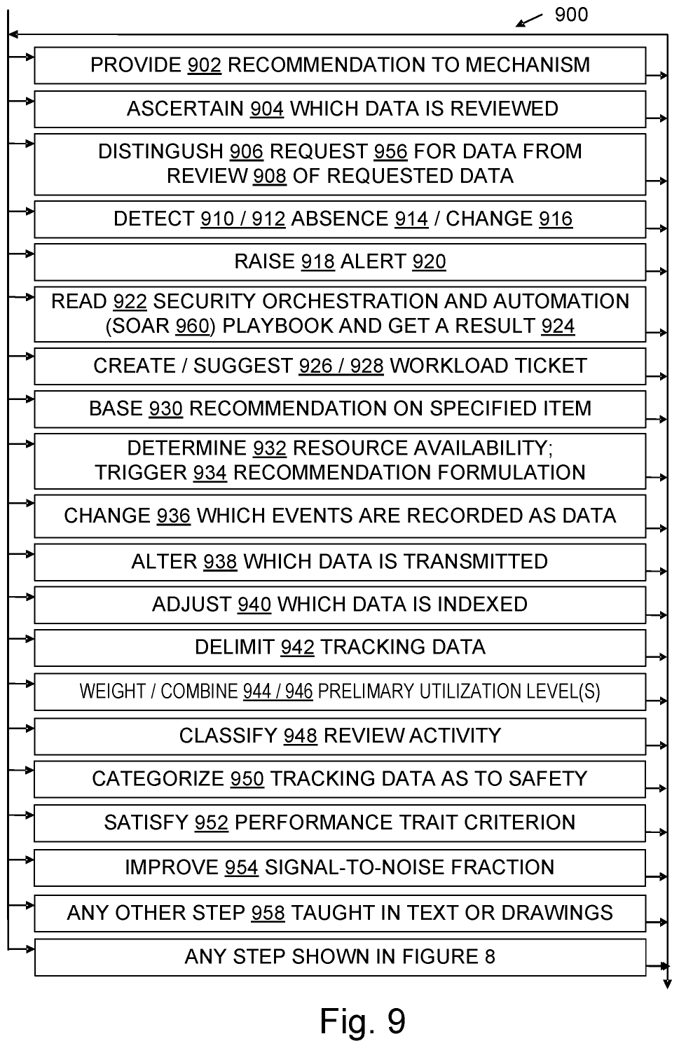

Methods (which may also be referred to as “processes” in the legal sense of that word) are illustrated in various ways herein, both in text and in drawing figures. FIGS. 8 and 9 illustrate families of methods 800, 900 that may be performed or assisted by an enhanced system, such as system 202 or another functionality 210 enhanced system as taught herein. FIG. 9 includes some refinements, supplements, or contextual actions for steps shown in FIG. 8, and incorporates the steps of FIG. 8 as options.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human may move a mouse 402 or type on a keyboard to command a computer to retrieve or display tracking data 124; these human activities may then be represented electronically by the computer as digital review activity data 220. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIGS. 8 and 9. Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 800 or 900 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method 900 for controlling computational resource usage, the method including: identifying 802 subsets 136 of tracking data 124; monitoring 804 review activities 218 which access 806 respective tracking data subsets 136; assigning 808 a utilization level 304 to a tracking data subset based 930 on at least a result 460 of the review activities monitoring; formulating 810 a retention recommendation 214 about the tracking data subset, the retention recommendation being based 930 at least on the utilization level; and implementing 812 the retention recommendation, thereby performing at least one of the following: reducing 606 retention 212 of tracking data 124 which is duplicative 508, cumulative 510, or non-impactful 512, or improving 954 a signal-to-noise fraction 564 of the tracking data 124.

Some embodiments distinguish 906 between requests 956 for tracking data and review 908 of requested tracking data 516, 124. This distinction may be made, e.g., when monitoring 804 review activities, when assigning 808 a utilization level, or when formulating 810 a retention recommendation.

One example of a circumstance permitting distinction 906 includes a user accidentally clicking a thirty-day button to request the past thirty days of a tracking data subset 136 when only the past seven days of that tracking data is actually being kept. In this case the distinction 906 may trigger 918 an informational message to the user, or even create a change ticket 644 to revise the user interface. Noting the distinction 906 may also prevent the non-existent data of the other twenty-three days from being treated as noise 562.

In some embodiments, a tracking data source may export a summary of available tracking data 124 that indicates, e.g., which dates are represented in the available tracking data. Configuring a user interface to offer unavailable tracking data may thus be avoided. In one scenario, a user at a client system 102 logs into a SIEM, the client fetches a summary indicating a time period for available tracking data on each index accessible to the logged in user, and the client user interface is configured to only show options that align with the tracking data available to the user. Tracking data 124 may be unavailable because it has not been retained, or because the user lacks necessary access permissions.

Another example includes an intentional and fulfillable request for thirty days of data, followed by an actual review of only the first ten days of the data, as indicated, e.g., by the user only paging through a first portion of the data 124 the user requested and received. In this case the distinction 906 allows the system 202 to assign a lower utilization level to the final twenty days of data than to the first ten days of data, which allows more accuracy in retention recommendations.

Some embodiments watch for an absence of expected tracking data or another unexpected change in tracking data flow. This can be accomplished by checking for statistically significant changes in the size of tracking data, or in the rate at which tracking data is received, for example. Data absence 914 or other changes 916 may be symptoms of a configuration change (either accidental or malicious), a throttling or other intervention by a service provider, or a hardware problem, for example.

In some embodiments, the method includes detecting 910 an absence 914 of expected tracking data 524, 124, and raising 918 an alert 920 in response to the absence. A system 202 could create a watch for tracking data 124, such that if the data 124 stops showing up an alert is generated.

In some embodiments, the method includes detecting 912 a change 916 in tracking data size 520 which exceeds a size change threshold 522, and raising 918 an alert 920 in response to the change. In some, the change could be prospective, in that changes to data retention settings that will lead to exceeding a certain threshold in terms of difference from the previous settings could trigger an alert. The size difference could be measured over a rolling n-day period.

In some embodiments, the formulated retention recommendation 214 includes at least one of: a recommendation of removal 604 of a particular subset of tracking data, a recommendation of non-removal 602 of a particular subset of tracking data, a recommendation of discontinuation 610 of generation of a particular subset of tracking data, a recommendation of continuation 612 of generation of a particular subset of tracking data, a recommendation of reduction 606 of a retention time 542 of a particular subset of tracking data, a recommendation of extension 614 of a retention time 542 of a particular subset of tracking data, a recommendation of tracking 222 of certain data 118 which is not currently part of the tracking data 124, an estimate 618 of a financial impact 620 of implementing the retention recommendation, a categorization 616 of a particular subset of tracking data as duplicative 508, a categorization 616 of a particular subset of tracking data as cumulative 510, or a categorization 616 of a particular subset of tracking data as non-impactful 512.

Review activities 218 such as queries about tracking data may be done via a GUI, through an API, through system commands, or otherwise. An embodiment may determine that queries 218 only include a subset of the full logs, either all the time or a lot of the time. The embodiment may take into account differences in queries over time, e.g., ascertaining whether queries on older data look different than queries on fresher data. The embodiment may recommend unused data fields for purging, possibly over time via a “slow-roll” aging out to reduce risk of adverse impact from deletion or other non-retention. An embodiment may make an additional suggestion such as something like “exclude this field in your log processing system, and if possible prevent your log forwarders from sending this data”.

An administrator might see a recommendation 214 and respond by creating a rule, e.g., a rule specifying that all authentication logs must not be truncated or altered in any way for 366 days in order to comply with a regulatory requirement they have. Given this new rule, the embodiment would not recommend deletion of those fields or rows. The rule could be implemented as a heuristic 558 or a requirement 628, for example. An embodiment may make an additional suggestion such as something like “add a note to the log processing system, forwarders, and documentation to definitely keep sending that log due to this rule”, and might provide a hyperlink to the rule.

With regard to an estimate 618 of a financial impact 620, a system 202 may have known data retention costs as well as cost per tier (e.g., cool or hot) of storage. Such costs might be estimated 618 in various ways. To the extent retention is billed to a cloud customer by a cloud service provider, e.g., as a service, the system may have access to pricing information for that customer for that service. Cost could also or instead be obtained as a value submitted by the user, or as an estimate based on industry samples. Accordingly, an embodiment might include in a recommendation 214 an estimate of the savings or other fiscal impact 620 of implementing the recommendation.

Unless otherwise stated, recommendations are based 930 at least partially on utilization levels 304, but other bases may also be used, such as company policies 630, government regulations 628, or aspirational goals 626. For example, a low utilization (relative to other subsets 136, or below a given absolute threshold 722) of a particular tracking data subset 136 may result in a recommendation of removal 604, or of discontinuation 610, or of retention time reduction 606, for that subset 136. Conversely, a high utilization (relative to other subsets 136, or above a given absolute threshold 722) of a particular tracking data subset 136 may result in a recommendation of non-removal 602, continuation 612, or retention time extension 614, for that subset 136.

With regard to goals and requirements underlying a recommendation 214, some embodiments may be able to receive as an input a goal 626 for certain data 124 in addition to hard requirements such as 628, 630, and 632. For instance, a regulation may require retaining 366 days of authentication data 124, 136 but a user may set a goal of retaining 732 days of such data.

Some embodiments use the requirements and goals to advise their formulation of recommendations 214. Some embodiments may also show an indicator of progress toward the user's goal as part of (or in conjunction with) the recommendations. For example, a recommendation may state something along the following lines: “You have not used this data, so we recommend removing this log category, this type of log entry, and these fields from the logs listed below. This will save you $123,456 per year in log retention costs, and will enable you to make progress toward goal #1 (authentication data retention for 732 days) from 366 days to 687 days at current rates. We have generated an incremental age-out policy to slow-roll this change for you. Would you like to Proceed?” Possible responses from the user may include “Yes”, “No”, or “Yes and force fast-roll (delete now; requires second administrator approval).”

A recommendation to track particular data 118 which is not currently part of the tracking data 124 may result from repeated or urgent or high authority requests 956 for that data 118 being made within a review activity 218 context. An embodiment might recommend logs that aren't currently tracked in this system 202 environments but are commonly used in other customers' environments with similar systems. This recommendation could be based on data notifying the system 202 what industry a company is in or what sorts of systems are on the company's network, or use cases, for example. Some of this may be intuited from the content of the logs themselves, e.g., based on keywords or industry codes.

Categorizations 616 characterizing the tracked subset 136 are likewise based on utilization levels 304. A categorization 616 may be included in a recommendation to better inform an admin about the expected or actual result of a recommendation implementation 812, e.g., “2 GB of duplicative data will no longer be retained”. A categorization 616 may also or additionally be used by the system 202 as a heuristic 558 or otherwise to prioritize subsets, e.g., ending or reducing retention of duplicative tracking data 508, 124 may have a higher priority than ending or reducing retention of cumulative tracking data 510, 124.

In some embodiments, the method includes reading 922 a security orchestration and automated response (SOAR) mechanism playbook 622, and formulating 810 the retention recommendation is based 930 at least in part on a result 924 of reading the security orchestration and automated response mechanism playbook.

SOAR playbooks 622 may contain rules that trigger actions based on events. For example, a SOAR playbook rule may specify that when malware is found on any machine, certain security logs 502, 124 for other machines 102 in the same department will be downloaded to a Security Operations Center SIEM 444 as soon as possible and then be proactively searched for events 532 such as file downloads, access to previously unknown IP addresses, and process creations, in order to help determine the breadth of the malware infection. After reading 922 this SOAR rule, the enhanced system 202 may increase the utilization level of the logs that would be downloaded and searched according to the SOAR rule, even if the SOAR rule has never been executed because no malware infections have been found. This could be treated as a precautionary utilization level increase, or the identification of a tracking data subset in a SOAR rule may itself be treated as a kind of utilization of that tracking data subset.

In some embodiments, the method includes creating 926 a ticket 644 in a workload management system 624, with the ticket including the formulated retention recommendation 214, e.g., in a human-readable textual form generally or as a script 116 in particular. In some, the method includes suggesting 928 a creation of a ticket in a workload management system, with the ticket including the formulated retention recommendation. Some embodiments perform both ticket creation suggestion and ticket creation. As an additional benefit, ticket creation data may serve in some situations as the evidence required for regulated industries. A system could provide its analysis and recommendations in the ticket itself, along with an identification of any data or models used, such that any model governance boards, data governance authorities, or the like would have auditable histories of why any particular subsets 136 were removed, scheduled for removal, or otherwise handled pursuant to the recommendation 214.

Some tickets or recommendations may target known systems. For instance, if a recommendation for retention time for a particular log field 536 is zero seconds, then the recommendation may additionally suggest configuring the log source system(s) to stop sending that particular field. This would help prevent network traffic and help reduce system loads overall.

In some embodiments, the formulated 810 retention recommendation 214 is also based 930 on at least one of: a legal requirement 628 represented by data accessed during the formulating, a company requirement 630 represented by data accessed during the formulating, a prediction 636 represented by data accessed during the formulating, an operational requirement 632 represented by data accessed during the formulating (e.g., do not purge a primary key of an index), an application dependency 634 represented by data accessed during the formulating, or a retention goal 626 represented by data accessed during the formulating (e.g., try to reduce daily log additions to 5 GB or less by the end of the fiscal year).

In some embodiments, implementing 812 the retention recommendation includes at least one of: changing 936 which events are recorded in tracking data (e.g., record less frequently, record fewer events, or record less detail about certain events), altering 938 which tracking data items are transmitted over a network (e.g., forward less frequently, forward fewer events, or forward less detail about certain events), or adjusting 940 which tracking data items are indexed for subsequent retrieval (e.g., index less frequently, index fewer events, or index less detail about certain events).

In some embodiments, at least one of identifying 802 subsets of tracking data, assigning 808 a utilization level, or formulating 810 a retention recommendation, includes delimiting 708 tracking data. In some, the delimiting 708 is based on at least one of: a particular data field 536 of a tracking data entry 538, thereby excluding another field of the tracking data entry; one or more particular times 542; an activity pattern 540; a particular user 104; a particular user group 544; a particular IP address set 546; a particular application 646; a particular service 548; a globally unique identifier 550; or a particular event set 552. Some illustrative scenarios are described herein, but one of skill understands that these are only illustrative examples, not a complete itemization of every scenario in which the present teachings can be beneficially applied.

Scenario A. From a SOAR 960 or SIEM 444, the system 202 receives notification of certain indicators of compromise (IOCs). For instance, an 10C notice may report that an identity directory database was backed up by an atypical means, or that a user logged on as an administrator when a required administrative access request had not been approved for that user or for that time, or both. In response, the system 202 may recommend preventing (or may proactively prevent) certain logs from rolling off, in order to preserve those logs as evidence. Accordingly, the atypical identity directory database backup may lead to delimiting 708 tracking data based on the identity directory service 548 and an event set 552 that contains a backup event. The atypical admin logon may lead to delimiting 708 tracking data based on an admin user group 544, time 542, and an event set 552 that contains a logon event.

Scenario B. The system 202 is notified or detects that available storage is nearing or past a critical threshold for available space 112. In response, the system may add to or modify its retention rules such that data is being more aggressively removed to avoid an availability incident. As a heuristic 558, a subset 136, 554 of all current but less historical data 124 may be favored over a subset 136, 556 of all historical and no current data 124 due to current data 124 no longer getting logged 222. Accordingly, the lack of available space may lead to delimiting 708 tracking data based on times 542 and a lack-of-space event 552.

Scenario C. Changes 916 to data retention exceed a threshold 522 in terms of difference from the previous values. In some cases, a change may be measured against a median or an average calculated over a rolling n-day period. An enhanced system 202 may help protect data against both mistakes and bad actors. Ensuring there is a cool-off between major changes allows the system time to accommodate changes, e.g., rebalance its recommendations, by taking into account how the tracking data is being used so that recommendations 214 are up to date and accurate. This further prevents some well-intentioned actors from becoming too aggressive with tracking data reductions; some embodiments provide a setting or command to override this, e.g., via a second user approval. Absence 914 detection 910 and change 916 detection 912 also help prevent a bad actor from being easily able to reduce retention to low or zero values in order to hide an intrusion.

Scenario D. In one variation, login attempts from a given IP address set 546 are not ever queried or viewed. In another variation, login attempts for a particular user are not ever queried or viewed. Accordingly, an entire log entry 538 (e.g., a full line) containing multiple fields 536 is recommended for removal if not covered by a rule 558 or a goal 626 dictating otherwise. This differs from field level removal, which removes only one or more fields of an entry without removing the entire entry.

In some embodiments, assigning 808 a utilization level includes at least one of: calculating a percentage 702 of a set 704 of review activities 218, calculating a review activity frequency 706, filtering tracking data based on a time 542, or delimiting 708 tracking data.

For example, a log file that is accessed by 15% of users during log reviews 218 may be assigned a higher utilization level than another log file that is accessed by 7% of users during log reviews 218. Also, tracking data that is reviewed 218 at least weekly may be assigned a higher utilization level than tracking data that is reviewed less frequently. As yet another example, tracking data that has been reviewed within the past 30 days may be assigned a higher utilization level than tracking data that has not. As to delimiting 708, in one example tracking data that has been reviewed as part of an end-of-month pattern 540 is assigned the greater of: a value calculated as discussed herein using other utilization level factors, and a minimum value that is large enough to make retention very likely unless the available storage space becomes very low.

In some embodiments, the method includes triggering 934 at least the formulation 810 of the retention recommendation in response to a determination 932 that an amount of available storage space has reached a predetermined available space threshold. Thus, in some cases low disk space availability could trigger a recommendation that decreases retention, or high disk space availability could trigger a recommendation that increases retention. In some embodiments, either can occur. In addition to the formulating 810, additional steps such as identifying 802 subsets of tracking data or assigning 808 a utilization level could also be triggered by reaching an available space threshold (high or low).

In some embodiments, formulating 810 the retention recommendation is based 930 at least in part on a heuristic 558 which favors 554 a specified subset of tracking data, or a heuristic 558 which disfavors 556 a specified subset of tracking data, or both. For example, one heuristic may be described as “all current but less historical data is often better than all historical and no current data due to data no longer getting logged”. Another heuristic may be described as “favor retaining data 124 that has been reviewed by a human over data 124 that is only reviewed by non-human mechanisms”. Human review may be indicated, e.g., by mouse movement 404, scrolling 436, or eye movement 440. Heuristics 558 may be implemented by software as priorities to apply when more than one retention recommendation otherwise meets all defined requirements and promotes all defined goals. Goals 626 differ from heuristics 558 in that goals set a retention target whereas heuristics help specify how to reach that target.

### Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as resource usage control software 302, tracking data subset delimitations 708, review activity monitoring mechanisms 306, tracking data control mechanisms 216, and retention recommendations 214, in the form of data 118 and instructions 116, read from a removable storage medium 114 and/or another source such as a network connection, to form a configured storage medium. The configured storage medium 112 is capable of causing a computer system 102 to perform technical process steps for resource usage control 208, as disclosed herein. The Figures thus help illustrate configured storage media embodiments and process (a.k.a. method) embodiments, as well as system and process embodiments. In particular, any of the process steps illustrated in FIG. 8 or 9, or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform a method for controlling computational resource usage. This method includes: identifying 802 a subset of tracking data; monitoring 804 one or more review activities for access to the tracking data subset; assigning 808 a utilization level to the tracking data subset based on at least a result of the review activities monitoring; formulating 810 a retention recommendation about the tracking data subset, the retention recommendation based at least on the utilization level; and implementing 812 the retention recommendation.

In some embodiments, assigning 808 the utilization level includes weighting 944 a first preliminary utilization level and combining 946 the weighted first preliminary utilization level with at least a non-weighted second preliminary utilization level or a weighted second preliminary utilization level. Some embodiments utilize a weighted utilization level 304, e.g., based on which user 104 or which team of users 104 is reviewing the tracking data. For example, admin review may receive greater a weight 710 than non-admin review, and review by Security Operations Center personnel may receive a greater weight 710 than review by other personnel.

In some embodiments, assigning 808 the utilization level includes classifying 948 a review activity as human-driven 714 or as machine-driven 716. Separate recommendations 214 may then be formulated 810, depending on whether the review is human-driven or not. For instance, changes in retention based on partially or entirely machine-driven reviews may be phased in more cautiously than changes based on reviews that are performed only by humans, in order to avoid breaking a service 548.

One of skill understands that methods 900 cannot be performed by a human mind alone, or with merely a pen and paper. The impracticality of controlling computational resources by mental efforts alone is clear to anyone responsible for administering or securing a computing system 102.

This impracticality is even greater for embodiments that are used commercially or by entities such as educational institutions, government agencies, or research facilities. In some of these embodiments, for example, a method 900 performed on behalf of an entity satisfies 952 at least one of the following performance trait 310 criteria: the identified subset 136 of tracking data has a storage size of at least one terabyte; the monitoring 804 monitors review activities from at least ten machines within a period of ten seconds; or the implementing 812 reduces retention of at least one terabyte of tracking data which is duplicative, cumulative, or non-impactful. Methods 900 satisfying these or similar criteria cannot be performed by a human mind alone, or with merely a pen and paper.

Some embodiments distinguish 948 between indexing 718 tracking data and visualizing 720 tracking data. Such a distinction 712 may result, e.g., in giving less weight 710 to indexing than to visualizing since indexing may be characterized as merely a possible step on a path to visualization. In some embodiments the method includes classifying 948 a review activity 218 as an indexing 718 review activity or as a visualizing 720 review activity during the utilization level assigning 808 or during the retention recommendation formulating 810, or both. Separate recommendations may also be given for different kinds 712 of review activity 218. For example, a recommendation may include an estimated cost of maintaining indexed tracking data in terms of processing power used, whereas no corresponding estimate is made as to data that is only visualized.

### Additional Observations

Additional support for the discussion of resource usage control herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, additional examples and observations are offered.

Some logging platforms allows field-level data removals, e.g., to comply with GDPR. Accordingly, a system 202 may effectively make retention recommendations at a field 536 level of granularity, e.g., by purging data 124 from within a given log item 538 after some time. This is different than removing an entire entry.

To illustrate fields 536 versus entries 538, consider the following hypothetical log entry:

Jul 15 02:04:59 combo sshd(pam_xnix)[21896]: authentication failure; logname=uid=0 euid=0 tty=NODEVssh ruser=rhost=128-135-151-1.ip.contoso.com user=root

Much of this data 124 could be useful to security admins doing their jobs. However, on this particular system the logname is blank. Accordingly, one could use a parsing tool 420 such as awk or another parser to extract fields of particular use into another data structure for further analysis. For instance, omitting the blank fields results in the following:

Jul 15 02:04:59 sshd(pam_xnix)[21896]: authentication failure; uid=0 euid=0 tty=NODEVssh rhost=128-135-151-1.ip.contoso.com user=root

In a similar manner, individual entry fields can be parsed from tracking data 124 that is kept in other formats, e.g., XML or JSON.

### Technical Character

The technical character of embodiments described herein will be apparent to one of ordinary skill in the art, and will also be apparent in several ways to a wide range of attentive readers. Some embodiments address technical activities such as parsing 420 logs 130, monitoring 804 usage of peripheral devices 106, creating 926 workload tickets 644, indexing 718 data 124, and tracking 222 data 118, 124, which are each an activity deeply rooted in computing technology. Some of the technical mechanisms discussed include, e.g., parsers 420, heuristic rules 558, resource usage control software 302, review activity tracking mechanisms 306, tracking data control mechanisms 216, and automatically formulated recommendations 214. Some of the technical effects discussed include, e.g., an improved signal-to-noise fraction 564, identification and removal of duplicative data 508, and identification and removal of underutilized or non-utilized tracking data 124. Thus, purely mental processes and activities limited to pen-and-paper are clearly excluded. Other advantages based on the technical characteristics of the teachings will also be apparent to one of skill from the description provided.

Different embodiments may provide different technical benefits or other advantages in different circumstances, but one of skill informed by the teachings herein will acknowledge that particular technical advantages will likely follow from particular innovation features or feature combinations.

For example, monitoring review activities which access respective tracking data subsets provides an automated, consistent, and efficient way to measure the usefulness of the respective subsets. Retention recommendations based on the measured usefulness can then be formulated and implemented. This is far better than simply changing data 124 retention and waiting for human users to object (“scream test”) or for a service to stop working properly. It is also better than measuring the usefulness of tracking data by taking an informal poll among human users who may not respond, or may respond erroneously. Moreover, a poll of human users ignores uses of tracking data by tools 122, services 548, SIEMS, or SOAR playbooks.

Implementing retention recommendations that have been formulated on a basis that includes tracking data subset 136 review activity 218 monitoring 804 provides as a benefit the capability of reducing resource usage 206 while limiting the risk of adverse impact on human users 104 and on services 548. The risk is limited in a controlled manner because the tracking data subsets 136 whose retention is being reduced or will be reduced can be limited to subsets 136 whose utilization level 304 is below a specified threshold.

Implementing retention recommendations that have been formulated on a basis that includes tracking data subset 136 review activity 218 monitoring 804 also provides as a benefit the possibility of reducing or terminating resource 204 usage that involves data 124, 136 which is merely duplicative 508 or cumulative 510. It may be that unutilized data 136 is not utilized because it contains no useful information. But it may also be the case that unutilized data 136 is not utilized even though it contains useful information, and the data is unutilized because that useful information is being derived from some other data subset 136 which is being utilized. For instance, the data 124 in a log X might be a duplicate of data in a log Y, and only log Y is accessed to get that data. Or the data 124 in an automatically generated report R might be cumulative of underlying data in a log Z, but report R is never read.

Implementing retention recommendations that have been formulated on a basis that includes tracking data subset 136 review activity 218 monitoring 804 also provides as a benefit the improvement of signal-to-noise fraction 564. This may be manifest as getting the same signal 560 from less resource usage 206, or it may be manifest as getting a stronger signal 560 from the same resource usage 206, for example.

Other benefits of particular steps or mechanisms of an embodiment are also noted elsewhere herein in connection with those steps or mechanisms.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to assess the extent to which tracking data 124 is actually needed. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples, operating environments, peripherals, kinds of tracking data 124, time examples, software process flows, security tools, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GDPR: General Data Protection Regulation

GPU: graphical processing unit

GUI: graphical user interface

GUID: globally unique identifier

IaaS or IAAS: infrastructure-as-a-service

ID: identification or identity

JSON: JavaScript® Object Notation (mark of Oracle America, Inc.).

LAN: local area network

OS: operating system

PaaS or PAAS: platform-as-a-service

RAM: random access memory

ROM: read only memory

SIEM: security information and even management, or tool for the same

SOAR: security orchestration and automated response, or tool for the same

TPU: tensor processing unit

UEFI: Unified Extensible Firmware Interface

WAN: wide area network

XML: eXtensible Markup Language

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventor asserts and exercises the right to specific and chosen lexicography.

Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein.

Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Resource usage control operations such as identifying 802 a data subset 136, monitoring 804 review activities that access 806 a data subset 136, assigning 808 a utilization level 304 to a data subset 136, formulating 810 a tracking data 124 retention recommendation 214, implementing 812 a tracking data 124 retention recommendation 214, and many other operations discussed herein, are understood to be inherently digital. A human mind cannot interface directly with a CPU or other processor, or with RAM or other digital storage, to read and write the necessary data to perform the resource usage control steps taught herein even in a hypothetical prototype situation, much less in an embodiment's real world environment 100 that satisfies 952 performance trait 310 criteria. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as accessing, adjusting, altering, ascertaining, assigning, categorizing, combining, classifying, creating, delimiting, detecting, determining, distinguishing, formulating, identifying, implementing, improving, monitoring, raising, reading, suggesting, weighting (and accesses, accessed, adjusts, adjusted, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### List of Reference Numerals

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as a “computational system” or “computing system”, and when in a network may be referred to as a “node”

104 users, e.g., user of an enhanced system 202; refers to a human or a human's online identity unless otherwise stated

106 peripheral device

108 network generally, including, e.g., LANs, WANs, software-defined networks, clouds, and other wired or wireless networks

110 processor; includes hardware

112 computer-readable storage medium, e.g., RAM, hard disks

114 removable configured computer-readable storage medium

116 instructions executable with processor; may be on removable storage media or in other memory (volatile or nonvolatile or both)

118 digital data in a system 102

120 kernel(s), e.g., operating system(s), BIOS, UEFI, device drivers

122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, applications (e.g., word processors, web browsers, spreadsheets, games, email tools, commands), and so on

124 tracking data, e.g., automatically generated data 118 which tracks a status, condition, actions, events, or other circumstance in a computing system over time; may be a measure per unit of an item; some examples include log data, system health data, performance data, security data, and activity data (e.g., logons per hour, licenses in use per month, views per day, and so on); may be stored in a file, blob, table, container, or other digital storage unit(s)

126 display screens, also referred to as “displays”

128 computing hardware not otherwise associated with a reference number 106, 108, 110, 112, 114

130 log data 124, e.g., security log, audit log

132 metric data 124, e.g., performance metric or health metric

134 cloud, cloud computing environment

136 subset of tracking data; may be defined by actual values it currently contains but is more likely to be defined by criteria that include or exclude specific values, e.g., based on time, source, or any other filtering criterion applicable to tracking data 124, including any combination of delimitation 708 criteria; e.g., “security logs from machine Dev123 for past 15 days and up to 15 days from now”, “user X send or receive events in the past ninety minutes”, “archival events performed for July or August”, “all logger configuration changes since tracking began”, all events involving a specified IP address range, all uses of a specified security token, and so on

202 system 102 enhanced with resource usage control functionality 210

204 resource, e.g., file or other digital storage item, virtual machine or other digital artifact, application or other tool 122, kernel 120, portion of memory 112, processor 110, display 126 or peripheral 106 or other hardware 128; any computational item susceptible to usage 206 in a system qualifies as a resource of that system; humans and other living beings, abstract ideas, and non-technical items are not resources 204

206 usage of a resource, e.g., storage in a memory 112 or retrieval from a memory 112, processing by a processor 110, transmission via a network 108, accessing a peripheral 106 or other hardware; usage occurs computationally—in a computing system—not as a human action

208 control of usage 206, e.g., conditioning, extending, terminating, expanding, decreasing, monitoring, prohibiting, permitting, securing, auditing, or otherwise computationally setting the system 102 conditions in which usage 206 occurs or may occur in the future; usage control occurs computationally in a computing system, not as a human action

210 resource usage control functionality, e.g., functionality which performs at least steps 804, 808, and 810, or software 302, or an implementation providing functionality for any previously unknown method or previously unknown data structure shown in any Figure of the present disclosure

212 retention of tracking data 124, e.g., storing data 124 in non-volatile memory 112 (which includes disks 112, tape 112, etc.), prolonging such storage, or preventing deletion of such stored data

214 retention recommendation, e.g., a digital data structure which represents instructions or conditions on retention 212

216 tracking data control mechanism, e.g., software or hardware which performs retention 212, or any configuration or settings which guide the operation of such software or hardware

218 tracking data review activity, e.g., a computational action which visualizes tracking data prior to storage of the tracking data in non-volatile storage, or a computational action which retrieves tracking data from non-volatile storage for subsequent visualization, indexing, or other processing; the review activity occurs computationally but it may be initiated by or be a result of either human action (e.g., menu click or typing) or machine action (e.g., script execution to select fields for display)

220 digital data representing tracking data review activity

222 computational creation of tracking data 124, e.g., a computation which tracks software events or hardware peripherals and emits log data or metrics data

302 software which upon execution controls 208 resource 204 usage 206, e.g., software which performs at least steps 804, 808, and 810, or software which performs at least steps 802, 804, 808, and 810, or software which performs at least steps 804, 808, 810, and 812, software which performs at least steps 802, 804, 808, 810, and 812

304 tracking data utilization level; digital; may be enumerative (e.g., low, medium, high) or numeric (e.g., 17 on a scale from 0 to 100, or 133 instances), for example; represents an extent to which a tracking data subset has been reviewed, but may also be subject to other factors such as requirements 628, 630, 632 or goals 626

306 review activity monitoring mechanism; includes hardware or software or both; some examples include monitors 410, 438, 442, 452, 456, 458

310 computing system performance trait; 310 also refers to a computing system performance trait as a criterion distinguishing a system from other systems; examples include having at least a minimum storage capacity, processing capacity, transmission capacity, or number of certain resources such as virtual machines, or meeting a specified efficiency goal such as the removal of at least a certain amount of duplicative or cumulative data

312 interface generally to a system 102 or portion thereof; may include, e.g., shells, graphical or other user interfaces, network addresses, APIs, network interface cards, ports

402 mouse peripheral device

404 mouse movement, e.g., translation through space or button click

406 peripheral movement generally; mouse movements, pen movements, and video game controller movements are some examples

408 mouse movement monitor, e.g., software or hardware or both that detects or otherwise receives notice of a mouse movement

410 movement monitor generally, e.g., software or hardware or both that detects or otherwise receives notice of a movement 406

412 attribute portion of an attribute-value pair 416

414 value portion of an attribute-value pair 416

416 attribute-value pair data structure which associates an attribute with a corresponding value, e.g., {“HeadAdmin”, “Pat Contoso”}

418 attribute-value pair parser, e.g., software that recognizes syntax of an attribute-value pair data structure sufficiently to navigate within the data structure or extract a value corresponding to a specified attribute; JSON data structures 124 may include attribute-value pairs

420 data structure parser software generally, which recognizes syntax of a data structure sufficiently to navigate within the data structure or extract a value from the data structure based on a specified condition such as a logical or arithmetic expression; some examples include parsers 418, 430, 434

422 log management program

424 shim, add-on, extension, or other plugin which extends the functionality of a piece of software; advantageous relative to code 426 because plugins may be developed and provided commercially by third parties who are not the originators of code 426; this may allow a legacy system to be retrofitted with functionality 210, e.g., by providing data 220 about field-level accesses with timestamps

426 software code with specific resource usage control functionality (e.g., functionality 210 or a portion thereof such as capacity to execute step 802 or step 804 or step 808 or step 810) residing within a surrounding program as an integral part of the surrounding program, as opposed to being a plugin

428 script for displaying content, e.g., script in a web page; digital

430 script parser; a parser 420 which recognizes script 428 syntax

432 command to an application or a kernel; digital

434 command parser; a parser 420 which recognizes command 432 syntax

436 scroll movement, e.g., up-down or sideways movement in a displayed digital document

438 scroll movement monitor, e.g., software or hardware or both that detects or otherwise receives notice of a scroll movement 436, e.g., via a pagination token

440 human eye movement, as detected by a system 102

442 eye movement monitor, e.g., software or hardware or both that detects or otherwise receives notice of an eye movement 440; this may allow a legacy system to be retrofitted with functionality 210 by providing data 220 about field-level accesses with timestamps

444 SIEM

446 software code 426 within a SIEM

448 page, e.g., web page or page in a word processor document; digital

450 presentation of a page 448, e.g., via display on a screen or emission from a printer

452 page presentation monitor, e.g., software or hardware or both that detects or otherwise receives notice of a page presentation 450

454 navigation command to change a focus or make a selection or request in an application or a kernel; digital; example of a command 432; includes, e.g., commands to mouse, trackpad, trackball, pen, touchscreen, microphone, and so on

456 navigation command monitor, e.g., software or hardware or both that detects or otherwise receives notice of a navigation command

458 peripheral monitor generally, e.g., software or hardware or both that detects or otherwise receives notice of a action by a peripheral device 106; examples include monitors 438, 438, 442, 452, 456

460 a digital result of review activities monitoring 804, e.g., an error code or data emitted by a monitor 458

502 log; a digital artifact

504 health metric, e.g., latency, number of hung processes, and so on; digital

506 performance metric, e.g., latency, processing speed, and so on; digital; notice that some items may be considered metrics of both health and performance

508 duplicate data, or the characteristic of being a duplicate, e.g., as a result of a system that is double-logging; also referred to as “duplicative”; non-duplicative data may also be identified, for example, two systems that appear to be the same (e.g., as to hostname) may have distinct logs

510 cumulative data, or the characteristic of being cumulative

512 impact or lack thereof (per context) on a system or system artifact

514 level of impact; digital; may be enumerative or numeric

516 data 118 requested for review but not necessarily yet reviewed or ever reviewed; 516 may also refer to the request artifact or the computational action of requesting

518 data 118 actually reviewed, e.g., displayed on a screen, printed, or relied on by a SOAR playbook, and so on; 220 refers to any review artifact and 218 refers to the computational action of reviewing

520 size, e.g., in megabytes or another appropriate unit depending on what has the size in question; may refer to tracking data 124 or to resources used during the storage, processing, or transmission of tracking data, for example

522 size change threshold, e.g., numeric value

524 data 118 that is expected based on past behavior of a system; also refers to the characteristic of being expected

526 recorded data 118, e.g., data in memory 112

528 transmitted data 118, e.g., data sent over a network 108 or by direct memory access

530 indexed data 118, e.g., data in a database

532 event; digital artifact representing something that occurred, with an explicit or implicit time of occurrence

534 item; digital artifact which does not necessarily have an explicit or implicit time of occurrence

536 data 118 field within a line, entry, object, table, or other larger data structure that encompasses the field; may refer to the current value of the field or to the field as a variable

538 line or other entry containing multiple fields 536

540 pattern of tracking data accesses, e.g., weekly or monthly, as embodied in a template or other data structure; digital artifact

542 time, in appropriate unit (from nanoseconds to months, depending on context); may include or consist of a date; may be a single point in time or a range of times, depending on context; digital

544 group of users; digital artifact

546 IP address (IPv4 or IPv6); digital

548 computational service, e.g., storage service, kernel service, communications service, provisioning service, monitoring service, daemon, interrupt handler, networking service, virtualization service, identity service, etc.

550 globally unique identifier (GUID); digital; may also be referred to as a universally unique identifier (UUID)

552 set of one or more events 532; digital

554 favored subset 136 or computational action of favoring a subset by enabling, promoting, or requiring retention of the subset

556 disfavored subset 136 or computational action of disfavoring a subset by enabling, promoting, or requiring non-retention or reduced retention of the subset

558 heuristic rule; computational or digital or both

560 signal, e.g., a measure of data 124, 518 that is actually reviewed

562 noise, e.g., a measure of data 124 that is not actually reviewed

564 signal-to-noise fraction; referred to as “fraction” rather than “ratio” to emphasize that formulas used to calculate a signal-to-noise fraction are not limited to the same or similar form as those used to calculate a signal-to-noise ratio in the information theory sense

602 computational action of avoiding removal of tracking data, or result of such action

604 computational action of removing tracking data, or result of such action

606 computational action of reducing tracking data retention, or reducing usage of resources which store, process, or transmit tracking data, or result of such action

608 computational action of adding to tracking data retention, or result of such action

610 computational action of discontinuing tracking data retention, or result of such action

612 computational action of continuing tracking data retention, or result of such action

614 computational action of extending tracking data retention, or result of such action

616 computational action of characterizing a tracked subset 136 as to a characteristic 508, 510, or 512, based on static or dynamic analysis of software, comparison with possible duplicates, or other tools and techniques used in other contexts

618 computational action of estimating a financial impact, or an estimate of such impact

620 financial impact as represented digitally

622 SOAR playbook, or characteristic of being based on a SOAR playbook; digital

624 workload management system, e.g., Azure® DevOps Boards software (mark of Microsoft Corporation), GitHub® Issues software (mark of GitHub, Inc.), Jira® software (mark of Atlassian Pty Ltd), and so on, or a “TODD” task within the code itself on linked projects, as seen in some Visual Studio® tools (mark of Microsoft Corporation)

626 goal as represented in a computing system

628 regulation or other legal requirement as represented in a computing system, e.g., a constraint to enforce in-jurisdiction-only storage of certain data 118

630 company policy or other entity (business, institution, agency, etc.) requirement as represented in a computing system, e.g., a requirement that two administrators approve any change to an auditing configuration file 216

632 operational requirement as represented in a computing system, e.g., a requirement that certain data 118 be stored in at least two data centers at least 100 kilometers apart

634 application dependency, or characteristic of being based on an application dependency; digital; e.g., SOARs and SIEMs are applications which often depend on other applications such as anti-virus tools, exfiltration detection tools, and so on; as another example, many software-as-a-service or other applications depend on underlying or embedded logging applications or identity directory applications; in some environments applications have a machine-readable set of dependencies and requirements, so if an application has specific requirements that may interact with the system, they may be indicated

636 prediction of future need or characteristic of being based on a prediction; a system may have policies set by administrators regarding which types of data should not be recommended for removal or shortening retention, based on an understanding of a future need (a prediction 636) that extends beyond a time horizon which the system has incorporated into its models and recommendation engines

638 availability of storage or another resource

640 computational action of determining an availability 838, or a result of such an action

642 availability threshold; digital

644 ticket, todo, or similar task data structure

646 application program

702 percentage of a set 704 of review activities; digital

704 set of review activities 218 or corresponding data 220; digital

706 review activity frequency; digital

708 computational action of delimiting a subset 136, or result of such action; digital

710 weight; digital

712 kind or type or class or category of review activity 218 or data 220; digital

714 characteristic of being human-driven or presumably human-driven, as represented by a digital value; pertains to review activity 218 or data 220

716 characteristic of being machine-driven or presumably machine-driven, as represented by a digital value; pertains to review activity 218 or data 220

718 computational action of indexing data, e.g., creating a database index, search tree, hash table, or similar data structure that makes faster than linear time search possible; also refers to resulting index or other faster-search-aiding data structure

720 computational action of visualizing data, e.g., putting data into a form that can be perceived by human senses (sight, sound, touch; may also refer to visualized data depending on context

722 utilization level threshold; enumerative or numeric; digital

800 flowchart; 800 also refers to resource usage control methods illustrated by or consistent with the FIG. 8 flowchart

802 computationally identify a subset 136, e.g., using data structures to delimit the subset

804 computationally monitor at least one review activity, e.g., using a mechanism 306

806 computationally access data

808 computationally calculate and assign a utilization level to a subset 136; more is presumably involved than the computational equivalent of a single assignment statement—calculation of the value 304 being assigned is also part of step 808 unless stated otherwise

810 computationally formulate a retention recommendation

812 computationally implement a retention recommendation

900 flowchart; 900 also refers to resource usage control methods illustrated by or consistent with the FIG. 9 flowchart (which incorporates the steps of FIG. 8)

902 computationally provide a recommendation, e.g., via an API, script, replacement configuration, or otherwise

904 computationally ascertain which data is actually reviewed, e.g., by checking for human activity or direct use in a SIEM or SOAR

906 computationally distinguish a request for data from actual review of data

908 computational review of data

910 computationally detect an absence of data 124, e.g., by timeout, smaller than expected data size, error code from file system, null search result, etc.

912 computationally detect change of data 124 from what is expected, e.g., by smaller than expected data size, smaller search result, etc.

914 absence of data 124, as detected or represented in system 202

916 change of data 124 or data type or size, as detected or represented in system 202

918 computationally raise an alert

920 alert; digital; e.g., text, email, packet, alarm, visual emphasis, etc.

922 computationally read (and implicitly, parse) a SOAR playbook

924 digital result of reading a SOAR playbook, e.g., a list of subset 136 delimiters used in the playbook

926 computationally create a ticket 644, e.g., via an API

928 computationally suggest creation of a ticket 644, e.g., by text in a recommendation or an alert

930 computationally base a recommendation on a specified item, e.g., basis is present if the recommendation would have been different or would not have been formulated absent the item

932 computationally determine resource availability, e.g., via a filesystem or kernel call

934 computationally trigger formulation of a recommendation, e.g., via a rule activation, API, or handler

936 computationally change which events are recorded as data 124

938 computationally alter which data 124 is transmitted

940 computationally adjust which events or other items are indexed using data 124

942 computationally delimit a subset 136

944 computationally weight a factor in a utilization level calculation, e.g., by multiplication

946 computationally combine factors in a utilization level calculation, e.g., by addition

948 computationally classify a review activity

950 computationally categorize tracking data as to likely or actual impact of retention recommendation

952 characteristic of a system having a performance trait and thus the action of the system satisfying a criterion calling for that performance trait

954 computationally improve an SNF, i.e., to increase it so there is more signal per unit of noise

956 request for tracking data

958 any step discussed in the present disclosure that has not been assigned some other reference numeral

960 security orchestration and automation; also referred to as SOAR

### Conclusion

In short, the teachings herein provide a variety of resource 204 usage 206 control 208 functionalities 210 which operate in enhanced systems 202. Computational resources 204 are used for storing, processing, or transmitting logs 502, 130, metrics 504, 506, 132, or other tracking data 124.

Usage 206 of such resources 204 may be reduced 606 by reducing 606 the retention 212 of identified 802 tracking data 124 subsets 136, based on 930 the subsets' 136 respective utilization levels 304, which in turn are based on results 460 of monitoring 804 activities 218 that review 908 a subset 136 or at least request 956 a subset 136 for review 908.

Efficient usage 206 of tracking data 124 subsets 136 may be increased 954, as measured by signal-to-noise fractions 564, wherein signal strength 560 corresponds to subset 136 utilization 304 in monitored 804 review activities 218, 220. Tracking data 124 resource 204 usage 206 efficiency 564 may be gained 954 whether the amount 520 of resources 204 used 206 is increased, maintained, or reduced.

Resource usage control functionality 210 may be integrated with security orchestration and automation 960, security information and event management 444, workload management 624, laws 628, entity policies 630, operational requirements 632, usage goals 626, or application dependencies 634, for example. The functionality 210 may be provided in legacy systems via retrofitting, or be integrated during the design and manufacture of systems, e.g., by fitting a system 102 with one or more monitors 306, parsers 420, other resource usage control mechanisms 306, 216, resource usage control software 302, 424, 426, 446, thereby forming an enhanced system 202.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware in documents. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIG. 8 or 9 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured for controlling computational resource usage, the computing system comprising:
a digital memory;
a processor in operable communication with the digital memory, the processor configured to perform safe computational resource usage control steps including: (a) identifying subsets of tracking data, the tracking data including event log data or computing system metric data or both, (b) monitoring review activities which access respective tracking data subsets, (c) assigning a utilization level to a tracking data subset based on at least a result of the review activities monitoring, (d) formulating a retention recommendation about the tracking data subset, the retention recommendation based at least on the utilization level; and (e) providing the retention recommendation to a tracking data control mechanism.

2. The computing system of claim 1, further comprising at least one of the following review activity monitoring mechanisms configured to ascertain which tracking data is reviewed:
a mouse movement monitor;
a navigation command monitor;
a display script parser;
a command parser;
an attribute-value pair data structure parser;
a plugin for a log management program;
a code operable in a log management program;
a code operable in or with a security information and event management program;
a scroll movement monitor;
a page presentation monitor; or
an eye movement monitor.

3. The computing system of claim 1, further comprising the tracking data control mechanism.

4. A method for controlling computational resource usage, the method performed by a computing system, the method comprising:
identifying subsets of tracking data;
monitoring review activities which access respective tracking data subsets;
assigning a utilization level to a tracking data subset based on at least a result of the review activities monitoring;
formulating a retention recommendation about the tracking data subset, the retention recommendation based at least on the utilization level; and
implementing the retention recommendation, thereby performing at least one of the following: reducing retention of tracking data which is duplicative, cumulative, or non-impactful, or improving a signal-to-noise fraction of the tracking data.

5. The method of claim 4, wherein the method comprises distinguishing between a request for tracking data and a review of requested tracking data.

6. The method of claim 4, further comprising at least one of:
detecting an absence of expected tracking data, and raising an alert in response to the absence;
detecting a change in tracking data size which exceeds a size change threshold, and raising an alert in response to the change.

7. The method of claim 4, wherein the formulated retention recommendation comprises at least one of:
a recommendation of removal of a particular subset of tracking data;
a recommendation of non-removal of a particular subset of tracking data;
a recommendation of discontinuation of generation of a particular subset of tracking data;
a recommendation of continuation of generation of a particular subset of tracking data;
a recommendation of reduction of a retention time of a particular subset of tracking data;
a recommendation of extension of a retention time of a particular subset of tracking data;
a recommendation of tracking of certain data which is not currently part of the tracking data;
an estimate of a financial impact of implementing the retention recommendation;
a categorization of a particular subset of tracking data as duplicative;
a categorization of a particular subset of tracking data as cumulative; or
a categorization of a particular subset of tracking data as non-impactful.

8. The method of claim 4, further comprising reading a security orchestration and automated response mechanism playbook, and wherein formulating the retention recommendation is based at least in part on a result of reading the security orchestration and automated response mechanism playbook.

9. The method of claim 4, wherein the method further comprises at least one of:
creating a ticket in a workload management system, the ticket including the formulated retention recommendation; or
suggesting creation of a ticket in a workload management system, the ticket including the formulated retention recommendation.

10. The method of claim 4, wherein the formulated retention recommendation is also based on at least one of:
a legal requirement represented by data accessed during the formulating;
a company requirement represented by data accessed during the formulating;
a prediction represented by data accessed during the formulating;
an operational requirement represented by data accessed during the formulating;
an application dependency represented by data accessed during the formulating; or
a retention goal represented by data accessed during the formulating.

11. The method of claim 4, wherein implementing the retention recommendation comprises at least one of:
changing which events are recorded in tracking data;
altering which tracking data items are transmitted over a network; or
adjusting which tracking data items are indexed for subsequent retrieval.

12. The method of claim 4, wherein at least one of identifying subsets of tracking data, assigning a utilization level, or formulating a retention recommendation, comprises delimiting tracking data based on at least one of:
a particular data field of a tracking data entry, thereby excluding another field of the tracking data entry;
one or more particular times;
an activity pattern;
a particular user; a particular user group; a particular IP address set; a particular application;
a particular service; a globally unique identifier; or a particular event set.

13. The method of claim 4, wherein assigning a utilization level comprises at least one of:
calculating a percentage of a set of review activities;
calculating a review activity frequency;
filtering tracking data based on a time; or
delimiting tracking data.

14. The method of claim 4, further comprising triggering at least the formulating of the retention recommendation in response to a determination that an amount of available storage space has reached a predetermined available space threshold.

15. The method of claim 4, wherein formulating the retention recommendation is based at least in part on a heuristic which favors a specified subset of tracking data, or a heuristic which disfavors a specified subset of tracking data, or both.

16. A computer-readable storage device configured with data and instructions which upon execution by a processor cause a computing system to perform a method for controlling computational resource usage, the method comprising:
identifying a subset of tracking data;
monitoring one or more review activities for access to the tracking data subset;
assigning a utilization level to the tracking data subset based on at least a result of the review activities monitoring;
formulating a retention recommendation about the tracking data subset, the retention recommendation based at least on the utilization level; and
implementing the retention recommendation.

17. The storage device of claim 16, wherein assigning the utilization level comprises weighting a first preliminary utilization level and combining the weighted first preliminary utilization level with at least a non-weighted second preliminary utilization level or a weighted second preliminary utilization level.

18. The storage device of claim 16, wherein assigning the utilization level comprises classifying a review activity as human-driven or as machine-driven.

19. The storage device of claim 16, wherein the method satisfies at least one of the following performance trait criteria:
the identified subset of tracking data has a storage size of at least one terabyte;
the monitoring monitors review activities from at least ten machines within a period of ten seconds; or
the implementing reduces retention of at least one terabyte of tracking data which is duplicative, cumulative, or non-impactful.

20. The method of claim 4, wherein the method comprises classifying a review activity as an indexing review activity or as a visualizing review activity during the utilization level assigning or the retention recommendation formulating, or both.
